(19) United States
(12) Patent Application Publication
(10) Pub. No.: US 2015/0100482 A1
(43) Pub. Date: Apr. 9, 2015

(54) PAYMENT TREE

(71) Applicant: eBay Inc., San Jose, CA (US)

(72) Inventors: Kamal Zamer, Austin, TX (US); Nikhil Vijay Thaker, Round Rock, TX (US); Jayasree Mekala, Austin, TX (US); Praveen Nuthulapati, Austin, TX (US); Jeremiah Joseph Akin, Pleasant Hill, CA (US)

(73) Assignee: eBay Inc., San Jose, CA (US)

(21) Appl. No.: 14/049,979

(22) Filed: Oct. 9, 2013

(51) Int. Cl. G06Q 20/10; G06Q 20/32; G06Q 50/00; G06Q 20/22

(52) U.S. Cl. CPC G06Q 20/102; G06Q 20/22; G06Q 20/3229; G06Q 50/01
USPC 705/40

(57) ABSTRACT

In an example embodiment, a group of local trusted devices is formed based, at least in part, on locations of a plurality of devices. Then a payment tree is presented in a user interface of a first device in the group of local trusted devices, the payment tree including a graphical representation of relationships between devices in the group and permitting selection, by a user of the first device, of one or more devices in the group to share in paying a bill received from a device outside the group. A bill may then be generated from the first device to each selected device in the payment tree, the bill indicating a payment amount reflecting a portion of the bill received from the device outside the group.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for establishing payments between mobile devices.

### BACKGROUND

The use of mobile devices, such as cell phones, smartphones, tablets, and laptop computers, has increased rapidly in recent years. In many cases, it is not uncommon for every member of a group to have a mobile device present during a joint activity, such as eating at a restaurant or taking a ride on a boat. However, there is no easy way to facilitate payments among members of such groups via their mobile devices.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments;

FIG. 3 is a diagram illustrating an example of forming a group of local trusted devices in accordance with an example embodiment.

FIG. 4 is a diagram illustrating a user interface in accordance with an example embodiment.

FIG. 5 is a diagram illustrating a user interface in accordance with an example embodiment.

FIG. 6 is a flowchart illustrating an example method, consistent with various embodiments described above.

FIG. 7 illustrates an example of a mobile device, according to various embodiments; and

FIG. 8 is a diagrammatic representation of a machine in the example form of a computer system within which a set of instructions, for causing the machine to perform any one or more of the methodologies discussed herein, may be executed.

### DETAILED DESCRIPTION

Example methods and systems for establishing a payment tree among a group of electronic devices are described. It will be evident, however, to one skilled in the art, that the present disclosure may be practiced without these specific details.

According to various exemplary embodiments, a mobile device self-identification system is configured to enable a mobile device to identify itself and its current location, or to output information to assist users in identifying or locating the mobile device. Through this process, a trusted group of devices currently at a location may be established. This may then enable the establishing and utilizing of a payment tree to request and distribute payments among the trusted group.

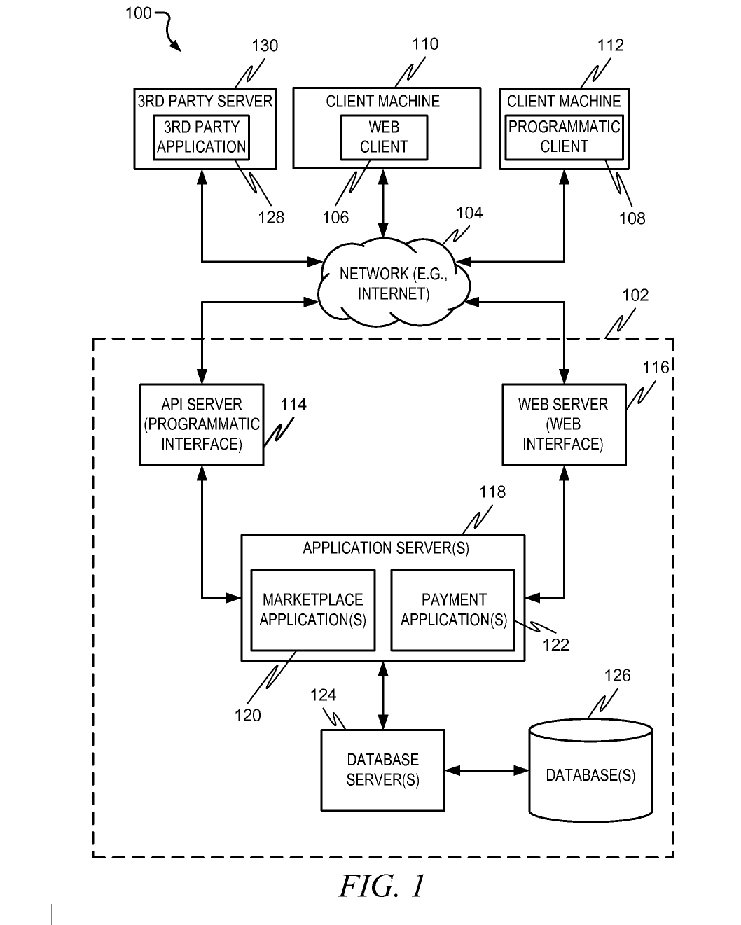

FIG. 1 is a network diagram depicting a client-server system 100, within which one example embodiment may be deployed. A networked system 102 provides server-side functionality via a network 104 (e.g., the Internet or wide area network (WAN)) to one or more clients. FIG. 1 illustrates, for example, a web client 106 (e.g., a browser), and a programmatic client 108 executing on respective client machines 110 and 112.

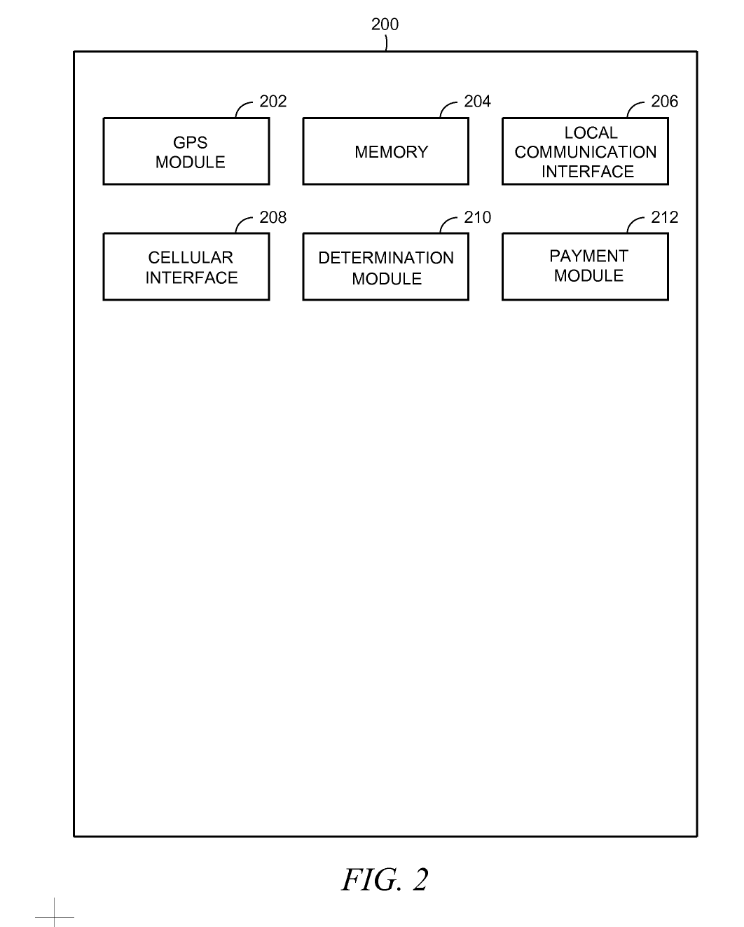

An application program interface (API) server 114 and a web server 116 are coupled to, and provide programmatic and web interfaces respectively to, one or more application servers 118. The application servers 118 host one or more applications 120 and 122. The application servers 118 are, in turn, shown to be coupled to one or more databases servers 124 that facilitate access to one or more databases 126. According to various exemplary embodiments, the applications 120 may be implemented on or executed by one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications 120 of the networked system 102.

FIG. 2 is a block diagram illustrating a mobile device self-identification system 200, in accordance with an example embodiment. The mobile device self-identification system 200 includes a global positioning system (GPS) module 202 which identifies a current location of the mobile device to which the mobile device self-identification system 200 may be a part. The mobile device self-identification system 200 may also include one or more memories 204. In one example embodiment, the memories 204 include information that uniquely identifies the mobile device or an account associated with the mobile device. This information may include, for example, a MAC address or other unique identification of the mobile device itself, or alternatively an account ID associated with, for example, a cellular phone or data plan associated with the mobile device. The latter may be stored, for example, on a SIM card or similar technology.

The mobile device self-identification system 200 may also include one or more local communication interfaces 206. The location communication interfaces may be any communication interfaces that allow for local communication between devices. These local communication interfaces 206 may allow the mobile device self-identification system 200 to directly communicate with other devices in the vicinity. This communication interface 206 may be used to, for example, send identification information among the devices in the vicinity, and send payment information. Examples of local communication interfaces 206 may include, but are not limited to, near-field communication (NFC), bluetooth, and WiFi. It should be noted that while this disclosure will describe the exchanging of information and payments between devices as being performed using these local communication interfaces 206, the same information could alternatively be passed via non-local communication interfaces 206, such as through a cellular network via a cellular interface 208. In such embodiments, location information from the GPS module 202 may be transmitted to a cellular server along with the identification information, which allows another server communicatively coupled to the cellular server to identify users within a designated radius of other users, and thus accomplishing the same identification of users within the local vicinity as using the local communication interfaces 206.

As stated above, identification information may be transmitted (e.g., broadcast) between mobile devices in the vicinity of one another. While this alone may form the basis of a group of local trusted devices, in many example embodiments more information is needed before deciding which mobile devices to add to a group of local trusted devices. This information could include information that tends to indicate that a particular mobile device is trusted. There are many possible examples of such additional information, and the information used may vary based on the type of users involved and even based on the location. For example, if the setting is a casual one, for example at a restaurant, amusement park, beach, etc., the factors utilized may tend to indicate that the users have some sort of social relationship to each other prior to forming the social group (or to adding new users to an existing group).

For example, in the case of a boating expedition, the system 200 may determine first that the location is near a body of water and deduce that a casual group should be formed. The system 200 may then utilize the identification information of users in the vicinity along with information indicating a social relationship in order to determine which users to add to the casual group. In an example embodiment, social networking information from a social network site can be used as a basis for this information. For example, if users within a particular location have connections (e.g., “friends”, “likes”, “follows” etc.) on a social network site, then it may be assumed that they are connected enough to be part of an ad-hoc casual group based on the fact that they are in the same location. Users that have no connection (e.g., passersby who are not part of the boating party) may simply not be added. The social network connections can be based on various degrees of connectivity, and a threshold may be set. For example, a first user may not be “friends” with every user in the group, but may be “friends” with a second user, who is friends with others, including a third user, in the group. This type of second degree relationship between the first user and the third user may form as a basis for establishing a trust between them and thus adding them to the same group of local trusted devices. The system 200 could indicate that, for example, social connections up to the sixth degree could be accepted for such “trust” to be established. Any such threshold (or no threshold at all) could be set. Indeed, it is also possible that individual users could set or adjust the threshold based on their own comfort level.

Another factor that could be utilized in determining whether to add particular users to a group of local trusted devices is time. If users have congregated in the same area for an extended period of time, this may be indicative of some sort of shared event or other similar level of trust. Thus, someone who is only in the boating area for a few minutes (e.g., an employee of a boat rental company) may not be added to the group of trusted devices, whereas someone who is in the boating area for an hour may be added.

As stated above, the type of location may also be useful in helping to identify whether users should be added to the group of trusted local devices, or even in determining which other factors to use. The location information may be compared with a map database or other database 126 to determine that the location is residential, public, business, etc. Different factors, thresholds, etc. may be utilized based on the classification of the location. Additionally, other environmental factors, such as speed information from the GPS module 202, may be utilized in making this determination as well. If the users have been in the vicinity of one another for 30 minutes, for example, but are all moving at 50 miles per hour, it may be assumed that the users are simply sharing the same train, and that no group of trusted devices should be established. Alternatively, if they have been in the vicinity of one another for the same 30 minutes while not moving, a group of trusted devices may be established.

Calendar information may also be accessed and utilized to aid in making the determination of which users to add to the group of local trusted devices. For example, if users in the same vicinity have the same event on their respective calendars, then it may be assumed that should be a part of a group of local trusted devices.

The groups and setting may also be user modifiable and overridable. For example, a first user may be added to a group of local trusted devices by virtue of the first user being in a relationship with a second user of the group. If that relationship ends, however, the second user could set various settings to remove the first user from the group.

Another set of information that could be utilized in determining the group of local trusted devices could include past financial payments. A financial payments server, for example, could be accessed to determine that a first user has made past payments to a second user, such that if the first user and the second user are in the same vicinity, it may be more likely that both should be added to the same group of local trusted devices than if no such past payments had been made.

Another set of information that could be utilized in determining the group of local trusted devices could include past groups of local trusted devices. For example, if a number of devices were previously joined in a group of local trusted devices by virtue of being at a party together, then it may be more likely that these devices could also be joined in a group of local trusted devices at a different location (such as a boat rental location).

The determination of the groups of local trusted devices may be performed, for example, on the mobile devices themselves, without relying on server-side processing. For example, a group determination module 210 on the mobile device may be utilized to determine which group to add the mobile device to, taking into account one or more of the factors described above. Alternatively, this group determination functionality could be located on a server. In some example embodiments, a combination of mobile device and server could be used for such processing.

A payment module 212 may be used to request and perform payments between users of trusted local groups. For example, a group leader (such as the organizer of a shared event, such as a boating outing, or simply someone who takes the lead as far as payment) could indicate users in a shared group of local trusted devices that need to make a payment or contribute to a payment. For example, the group leader may initiate a request to each of the group members for $20 for their portion of the bill.

The payment module 212 may also be used by the members of the group to actually facilitate the payment itself. For example, once the payment request is received by a user, the user can use the payment module 212 to actually pay the requested amount.

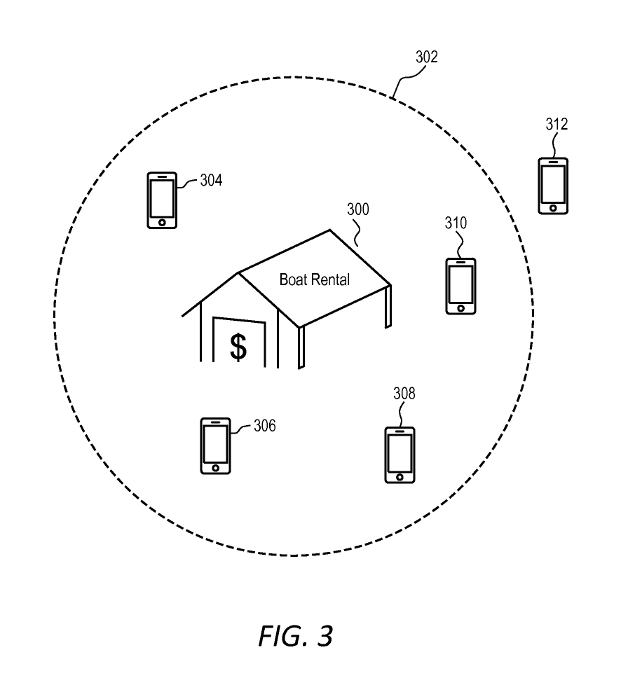

FIG. 3 is a diagram illustrating an example of forming a group of local trusted devices in accordance with an example embodiment. Here, the example reflects the above-described example of a boat rental location 300. Users within the vicinity 302 of the boat rental location 300 may be considered candidates for a group of local trusted devices. The vicinity 302 can be a certain area surrounding the boat rental location 300. This area may be defined in a number of different ways. In one example embodiment, the area may be defined as the area in which local communication protocols can be used for inter-device communication. As such, the area might be the distance that, for example, Wi-Fi interfaces on the various devices 304, 306, 308, 310, 312 can be in wireless communication with each other. In another example embodiment, a fixed distance can be established and precise coordinates from a GPS module 202 or other location-fixing device can be used to establish whether a device is within the vicinity 302 or not.

Here, devices 304-310 are within the vicinity 302 of the boat rental location 300 and thus may be considered candidates for addition to a group of local trusted devices. Device 312, however, is outside of the vicinity 302 and may not be considered as part of this group. Additionally, it may be that device 310 is only in the vicinity 302 for a brief period of time, and thus may not actually be added to the group.

As stated above, once there is a plurality of users within a group of local trusted devices, one or more of the users within the group can create a payment tree to request and process payments from some of the users within the group. The payment tree may be created in a number of different ways.

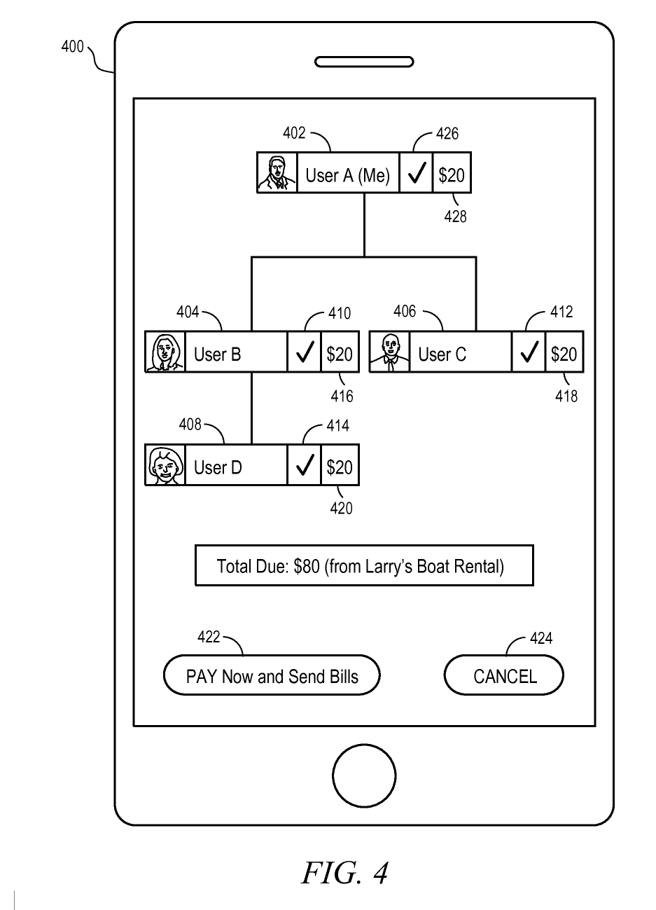

In an example embodiment, a user attempting to create a payment tree may be presented with a user interface that depicts graphically the relationships between the users of the shared group of trusted local devices. FIG. 4 is a diagram illustrating a user interface in accordance with an example embodiment. Assume that there is a bill received in a public place, such as at a boat rental facility. There may be five users in the vicinity 302, User A, User B, User C, User D, and User E. User A may receive a bill for $80 from the boat rental company. User A may then be presented with the user interface 400 in FIG. 4, which depicts graphically a connection between User A 402 and User B 404, and also between User A 402 and User C 406. User B 404 has a connection to User D 408. All of these connections may be based on relationship information, perhaps from social networking information. Notably, User E may not be depicted as User E may not be part of the shared group of trusted local devices. User A 402 may then select one or more check boxes 410, 412, 414 to indicate which users should receive a portion of the bill. User A 402 may also type amounts for each user in input boxes 416, 418, 420. These amounts indicate the portion of the total bill attributable to each user. In some example embodiments, the system 200 may automatically assume the bill is to be divided evenly and split the total amount among the various selected users (including, perhaps, the user creating the payment tree). Of course, there may be certain situations in which individualized amounts are more appropriate, such as in restaurants, where the various parties do not want to simply split the bill evenly, in which case the input boxes 416, 418, 420 can be used.

Once the User (here User A 402) has made all the selections and inputs, the user may select a “pay now” button 422, which may generate a payment from User A 402′s account to the company that sent the bill (e.g., the boat rental company). This may also have the effect of generating individual bills to the selected users (here, User B 404, User C 406, and User D 408), which can be payable directly to the user that generated the payment tree (here, User A 402).

Thus, User A has paid the boat rental company on behalf of the group, and will get reimbursed from the appropriate users in accordance with the payment tree. It should be noted that User A 402 may also have a checkbox 426 and an input box 428. While in many cases the user creating the payment tree may, as a default, also be contributing to the bill, there may be situations where the user creating the payment tree may not be contributing, and thus may wish to “uncheck” the checkbox 426, or may wish to pay a different amount, by altering the input box 428.

In another example embodiment, users may set various different trust levels for different classes of other users. For example, a user may set a preference that the user should only be added to groups containing all first degree relationships to the user (e.g., friends and family). In another example embodiment, the user may actually set different preference levels for different types of environments and/or transactions. For example, the user may indicate that if he or she is moving at a high speed with other users, only users in his or her family should be automatically formed into a group. In another example, a user may indicate that only first degree relationships are to be used as the basis for forming a group for purposes of splitting a restaurant bill, but that second and third degree relationships can be used for forming a group for purposes of splitting an outdoor event charge.

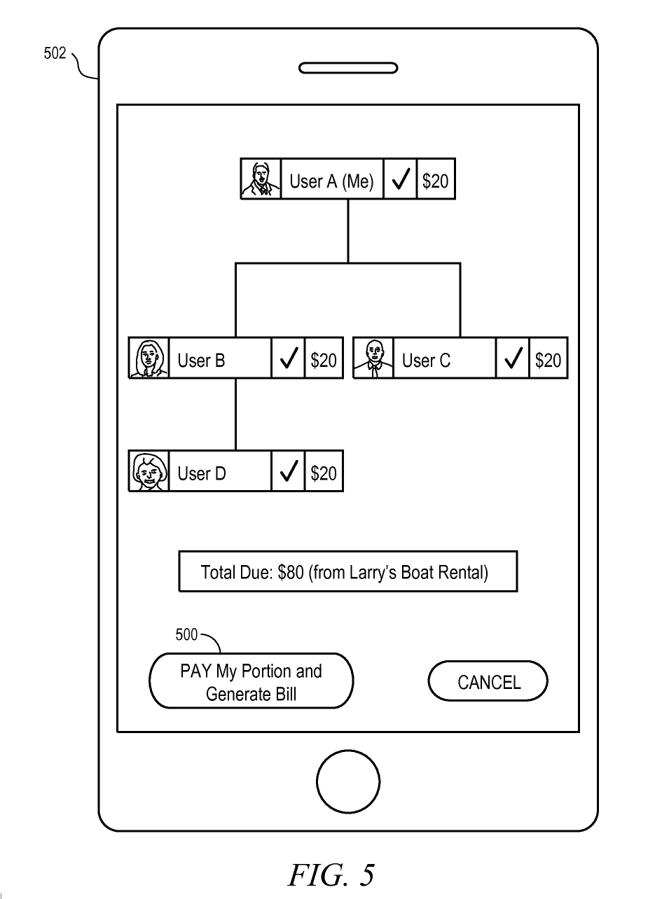

FIG. 5 is a diagram illustrating a user interface 502 in accordance with an example embodiment. Here, rather than the user who creates the payment tree paying the bill in full and getting reimbursed, he or she selects a “pay my portion and generate bill” button 500 of the user interface 502, causing the system 200 to pay his or her portion of the bill and generate invoices to other users selected in the payment tree so that they can pay their portions directly to the company that sent the bill.

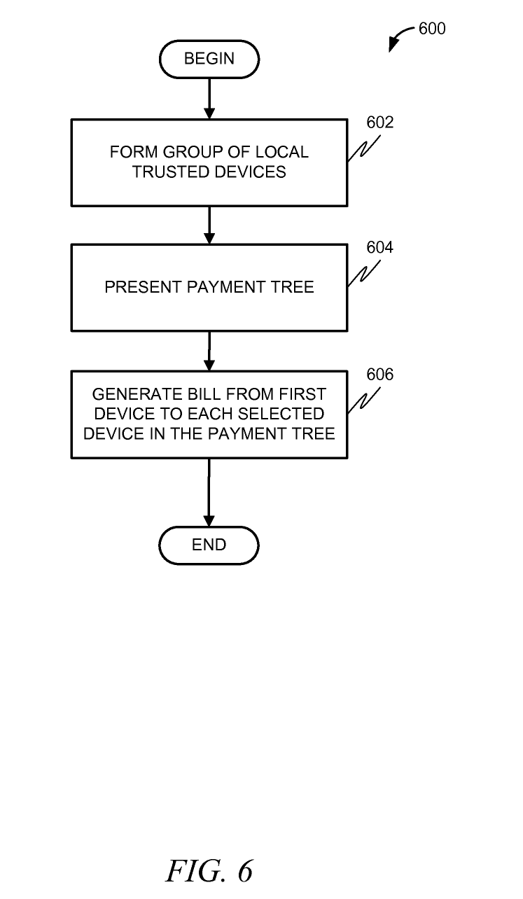

FIG. 6 is a flowchart illustrating an example method 600, consistent with various embodiments described above. The method 600 may be performed, at least in part, by, for example, the mobile device self-identification system 200 illustrated in FIG. 2 (or an apparatus having similar modules, such as client machines 110 and 112 or application server 118 illustrated in FIG. 1). In operation 602, the determination module 210 may form a group of local trusted devices based at least in part on locations of a plurality of devices. In operation 604, the payment module 212 may present a payment tree in a user interface 502 of a first device in the group of local trusted devices, the payment tree including a graphical representation of relationships between devices in the group and permitting selection, by a user of the first device, of one or more devices in the group to share in paying a bill received from a device outside the group. In operation 606, the payment module 212 may generate a bill from the first device to each selected device in the payment tree, the bill indicating a payment amount reflecting a portion of the bill received from the device outside the group.

### Example Mobile Device

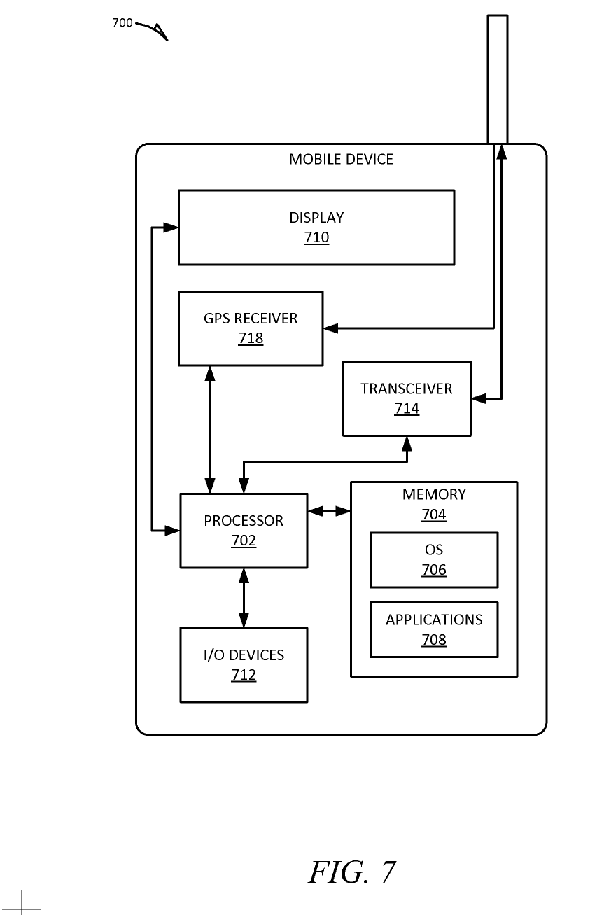

FIG. 7 is a block diagram illustrating a mobile device 700, according to an example embodiment. The mobile device 700 may include a processor 702. The processor 702 may be any of a variety of different types of commercially available processors 702 suitable for mobile devices 700 (for example, an XScale architecture microprocessor, a microprocessor without interlocked pipeline stages (MIPS) architecture processor, or another type of processor 702). A memory 704, such as a random access memory (RAM), a flash memory, or other type of memory, is typically accessible to the processor 702. The memory 704 may be adapted to store an operating system (OS) 706, as well as application programs 708, such as a mobile location enabled application that may provide LBSs to a user. The processor 702 may be coupled, either directly or via appropriate intermediary hardware, to a display 7010 and to one or more input/output (I/O) devices 712, such as a keypad, a touch panel sensor, a microphone, and the like. Similarly, in some embodiments, the processor 702 may be coupled to a transceiver 714 that interfaces with an antenna 716. The transceiver 714 may be configured to both transmit and receive cellular network signals, wireless data signals, or other types of signals via the antenna 716, depending on the nature of the mobile device 700. Further, in some configurations, a GPS receiver 718 may also make use of the antenna 716 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 702 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor 702 or other programmable processor 702) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 702 configured using software, the general-purpose processor 702 may be configured as respective different hardware-implemented modules at different times. Software may accordingly configure a processor 702, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors 702 or processor-implemented modules. The performance of certain of the operations may be distributed among the one or more processors 702, not only residing within a single machine, but deployed across a number of machines. In some example embodiments, the processor 702 or processors 702 may be located in a single location (e.g., within a home environment, an office environment or as a server farm), while in other embodiments the processors 702 may be distributed across a number of locations.

The one or more processors 702 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 702, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 702 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor 702), or a combination of permanently and temporarily configured hardware may be a design choice. Below are set out hardware (e.g., machine) and software architectures that may be deployed, in various example embodiments.

### Example Machine Architecture and Machine-Readable Medium

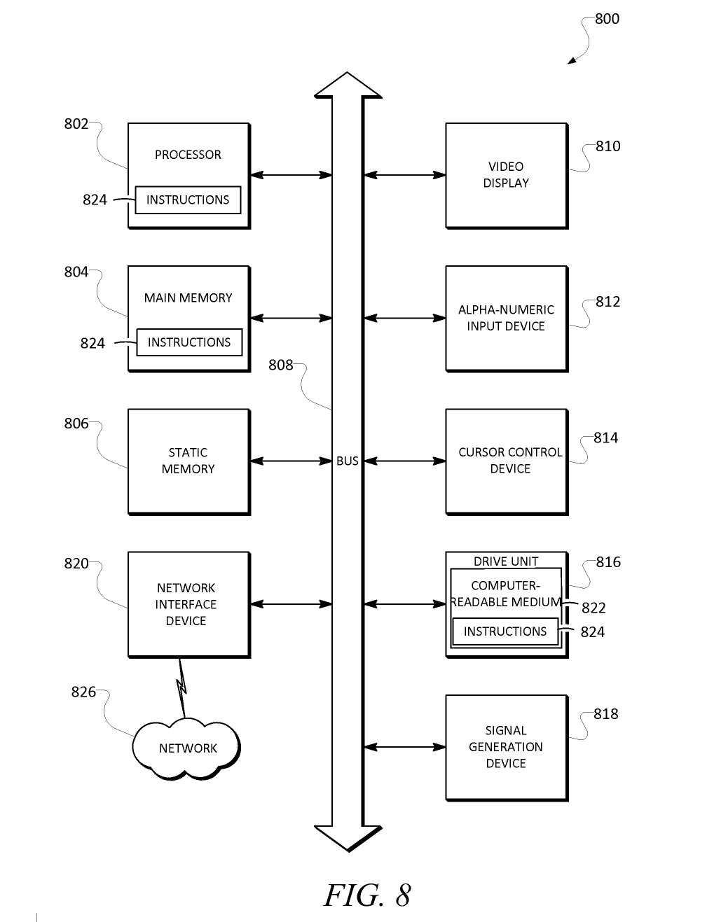

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media 822.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions 824 for execution by the machine and that cause the machine to perform any one or more of the methodologies of the present disclosure or that is capable of storing, encoding or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 824 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A device comprising:
a memory including a unique identification of the device or an account associated with the device;
a local communications interface configured to transmit the unique identification to one or more devices within a vicinity of the device;
a group determination module executable by a processor and configured to form a group of local trusted devices based, at least in part, on locations of the one or more devices within a vicinity of the device; and
a payment module configured to present a payment tree in a user interface of a first device in the group of local trusted devices, the payment tree including a graphical representation of relationships between devices in the group and permit selection, by a user of the first device, of one or more devices in the group to share in paying a bill received from a device outside the group, and to generate a bill from the first device to each selected device in the payment tree, the bill indicating a payment amount reflecting a portion of the bill received from the device outside the group.

2. The device of claim 1, further comprising a global positioning system (GPS) module configured to provide location information of the device, the location information used by the group determination module of the device or of another device in the vicinity of the device.

3. The device of claim 1, wherein the unique identification is a media access control (MAC) address.

4. The device of claim 1, wherein the unique identification is a telephone number stored in a subscriber identity module (SIM) card of the device.

5. The device of claim 1, wherein a device is within a vicinity of another device if the devices are within range of the local communications interface.

6. The device of claim 1, wherein a device is within a vicinity of another device if the devices are within a preset distance of each other.

7. A method comprising:
forming a group of local trusted devices based, at least in part, on locations of a plurality of devices;
presenting a payment tree in a user interface of a first device in the group of local trusted devices, the payment tree including a graphical representation of relationships between devices in the group and permitting selection, by a user of the first device, of one or more devices in the group to share in paying a bill received from a device outside the group; and
generating a bill from the first device to each selected device in the payment tree, the bill indicating a payment amount reflecting a portion of the bill received from the device outside the group.

8. The method of claim 7, wherein the forming the group of local trusted devices includes utilizing social networking site relationship information to determine if devices within a vicinity of each other should be part of the group.

9. The method of claim 7, wherein the forming the group of local trusted devices includes:
identifying a shared location of a plurality of local trusted devices;
classifying the shared location based on location type;
utilizing factors that are based on the location type to determine which of the plurality of local trusted devices to add to the group based on the location type.

10. The method of claim 7, wherein the forming the group of local trusted devices is also based on an amount of time each of the plurality of devices spend in a shared location.

11. The method of claim 7, wherein the forming the group of local trusted devices is also based on calendar entries of one or more of the devices.

12. The method of claim 7, wherein the forming the group of local trusted devices is also based past financial payments made between the devices.

13. The method of claim 7, wherein the forming the group of local trusted devices is also based previous groups of local trusted devices to which one or more of the devices belonged.

14. The method of claim 7, wherein the bill from the first device is a bill to pay the first device, which has itself paid the device outside the group.

15. The method of claim 7, wherein the bill from the first device is a bill to pay the device outside the group directly.

16. A non-transitory machine-readable storage medium having embodied thereon instructions executable by one or more machines to perform operations comprising:
forming a group of local trusted devices based, at least in part, on locations of a plurality of devices;
presenting a payment tree in a user interface of a first device in the group of local trusted devices, the payment tree including a graphical representation of relationships between devices in the group and permitting selection, by a user of the first device, of one or more devices in the group to share in paying a bill received from a device outside the group; and
generating a bill from the first device to each selected device in the payment tree, the bill indicating a payment amount reflecting a portion of the bill received from the device outside the group.

17. The non-transitory machine-readable storage medium of claim 16, wherein the forming the group of local trusted devices includes utilizing social networking site relationship information to determine if devices within a vicinity of each other should be part of the group.

18. The non-transitory machine-readable storage medium of claim 16, wherein the forming the group of local trusted devices includes:
identifying a shared location of a plurality of local trusted devices;
classifying the shared location based on location type;
utilizing factors that are based on the location type to determine which of the plurality of local trusted devices to add to the group based on the location type.

19. The non-transitory machine-readable storage medium of claim 16, wherein the forming the group of local trusted devices is also based on the amount of time each of the plurality of devices spend in a shared location.

20. The non-transitory machine-readable storage medium of claim 16, wherein the forming the group of local trusted devices is also based on calendar entries of one or more of the devices.
